(19) United States
(12) Patent Application Publication
(10) Pub. No.: US 2025/0322407 A1
(43) Pub. Date: Oct. 16, 2025

(54) SYSTEMS AND METHODS FOR PROACTIVELY PROVIDING EMOTIONALLY INTELLIGENT INTERACTION GUIDANCE USING A MACHINE LEARNING FRAMEWORK

(71) Applicant: Wells Fargo Bank, N.A., San Francisco, CA (US)

(72) Inventors: Gregory Morishige, San Francisco, CA (US); Tanisha Patterson-Powe, Huntersville, NC (US); Jaclyn Olmos-Lym, San Francisco, CA (US)

(21) Appl. No.: 18/637,163

(22) Filed: Apr. 16, 2024

(51) Int. Cl. G06Q 30/015; G06N 5/04; G06N 7/01

(52) U.S. Cl. CPC G06Q 30/015; G06N 5/04; G06N 7/01

(57) ABSTRACT

Systems, apparatuses, methods, and computer program products are disclosed for providing emotionally intelligent interaction guidance. An example method includes detecting a user interaction event for a user within an environment and receiving media pertaining to the user. The example method further includes determining an inferred emotional classification for the user based on the received media. The example method further includes generating the emotionally intelligent interaction guidance based on the inferred emotional classification using a guidance machine learning model and providing the emotionally intelligent interaction guidance to an entity device.

### BACKGROUND

Frontline agents engage with individuals on behalf of an associated organization during customer interactions. During these customer interactions, frontline agents may directly interface with the customer to facilitate various customer requests and manage any customer inquiries or questions. Additionally, frontline agents must exhibit emotional intelligence and awareness during these interactions to ensure a pleasant experience for all parties.

### BRIEF SUMMARY

Frontline agents directly interface with various customers throughout the day to perform various customer requests, answer customer inquiries, and even proactively anticipate and address customer needs. Frontline agents must also exhibit emotional intelligence and awareness during these customer interactions to ensure a pleasant experience. Failure to do so may result in customer frustration, which may result in unpleasant experience between the customer and frontline agent and further, may harm the organization's reputation. Therefore, it is imperative that frontline agents interact with the customer in an emotionally intelligent manner and further, that is responsive to the customer's current emotional state.

However, frontline agents are often subject to high volumes of customer interactions, which may be high-stress and emotionally draining. Furthermore, frontline agents may lack the experience, skills, or support to navigate difficult and/or emotionally charged situations. While various training protocols may be offered to frontline agents to prepare them for customer interactions, these training protocols do not address the real-time demands and expectations of customers during live customer interactions. Thus, while these training protocols may aid in prepping the frontline agent, the burden is still on the frontline agent to address and analyze each customer interaction and determine appropriate responses in an emotionally intelligent manner.

Furthermore, the environment in which these customer interactions occur can heavily impact the customer experience and customer emotional state, such as through the sensory experience for the customer. For example, environmental factors such as lighting, music, fragrance, and overall environmental ambiance are contributors to customer mood and may affect emotional state. Currently, the majority of environmental factors of an environment, such as a branch of a financial institution, are static and not modifiable. In instances where these environmental factors are modifiable, manual intervention is required to result in the altered environmental state.

In contrast to these conventional methods of facilitating a customer/user interaction within an environment, example embodiments described herein allow for emotionally intelligent interaction guidance that is responsive to the customer's current emotional state to be provided directly to the frontline agent with whom they are interacting. The frontline agent is then presented with the customer's current emotional state, as indicated by the inferred emotional classification determined for the customer, such that frontline agent may direct the interactions with the user in an emotionally intelligent and aware manner. Furthermore, the emotionally intelligent interaction guidance may further include one or more recommended actions the frontline agent may use to enhance the user interaction. These recommended actions may be responsive to the inferred emotional classification for the user and thus, the frontline agent may automatically be presented with actions he/she can take to facilitate an emotionally intelligent user interaction. In some examples, these recommended actions may be verbal cues, physical cues, or auditory cues the frontline agent may perform to facilitate interaction with the user. As such, the manual burden of assessing the emotional state of an individual user and determining an emotionally intelligent response to the user is removed from the frontline agent, resulting in an enhanced and more pleasant user experience for the user and the frontline agent. Furthermore, the emotionally intelligent interaction guidance may be updated and periodically or continuously provided to the frontline agent such that the frontline agent may be presented with an accurate and up-to-date assessment of the user's emotional state and responsive recommended actions.

Accordingly, the present disclosure sets forth systems, methods, and apparatuses that generate and provide emotionally intelligent interaction guidance to a frontline agent to enhance a user interaction experience. In doing so, example embodiments described herein automatically provide the frontline agent with an indication of the emotional state of the user, such that they need not manually make this determination. Furthermore, frontline agents may be automatically presented with recommended actions they may take to facilitate a pleasant user interaction, thereby removing the guesswork of what actions are appropriate. In addition to facilitating the more pleasant user interaction experience, the emotionally intelligent interaction guidance may also aid in relieving the stress and emotionally drain experienced by frontline agents.

To provide the emotionally intelligent interaction guidance, embodiments described herein a user interaction event may be determined upon a user entering an environment, such as a branch of a financial institution. For the duration of the user interaction event (e.g., until a user interaction termination event is determined), media may be received. This media may be evaluated to determine if it pertains to the user. The received media may be formatted in various media types such that various types of information relating to the user may be considered when determining an inferred emotional classification. Consideration of the various media types may allow for a more robust and accurate determination of an inferred emotional classification for the customer. The received media may be processed to extract user characteristics and these user characteristics may be provided to an emotional intelligence machine learning model. The emotional intelligence machine learning model may process the user characteristics to determine an inferred emotional classification for the user. In particular, the emotional intelligence machine learning model may infer and assign a probability to a plurality of candidate emotional classifications that is indicative of the probability that the user possesses the corresponding emotion and determine the inferred emotional classification for the user based on these probabilities.

Furthermore, in some embodiments, the emotional intelligence machine learning model may be configured to first determine a probability for one or more candidate core emotions. These candidate core emotions may be characterized by distinct user characteristics that may be fundamental or consistent across various populations, cultures, and demographics. Thus, the emotional intelligence machine learning model may leverage this consistency to determine a probability that the user possesses this candidate core emotion (or a related candidate emotional classification) and use these probabilities to filter candidate emotional classifications. In particular, certain candidate emotional classifications may be associated with or related to a candidate core emotion. Thus, only candidate emotional classifications, including the candidate core emotions, associated with selected candidate core emotions may be considered and a probability determined for. This effectively reduces overall computational resource usage by restricting the pool of candidate emotional classifications to only those determined to be relevant while still maintaining accuracy.

A guidance machine learning model may then be used to process the inferred emotional classification and generate the emotionally intelligent guidance. The guidance machine learning model may identify and determine candidate actions based on the inferred emotional classification, such that the candidate actions are responsive and effective actions to the user's inferred emotional classification. Additionally, the guidance machine learning model may consider a current temporal range of the user interaction (e.g., early stage, intermediate stage, end-stage) such that the candidate actions determined are appropriate for the particular stage of the interaction. The guidance machine learning model may then determine an inferred emotional responsiveness classification for each determined candidate action and select the candidate actions based on this classification. Candidate actions may be selected if it is determined the candidate action would be helpful for the user interaction. These selected candidate actions may be included as recommended actions in the emotionally intelligent interaction guidance, which may also include the inferred emotional classification for the user. The emotionally intelligent interaction guidance may then be provided to the frontline agent for use during the interaction.

Additionally, in some embodiments, an inferred emotional classification for a user may prompt a change in the environment. In particular, consideration of the current environmental settings may be compared to optimized environmental settings for a given emotional classification. If the optimized environmental settings differ from current environmental settings, example embodiments may automatically cause one or more changes in the environment to adjust the environmental settings to be inline with the optimal environmental settings. As such, the environmental settings may be modified and responsive to the user's emotional state, thereby facilitating a more pleasant user experience.

Furthermore, in some embodiments, an escalation event may automatically be determined based on the user's inferred emotional classification. In some embodiments, an escalation event may be of a safety type, such as when a user is behaving aggressively. The escalation event may alert appropriate personnel, such as security officers, to step in to handle the situation. An escalation event may also be a user experience type. A user experience escalation event may not involve safety but instead, may alert another agent, such as a manager, supervisor, or other administrator of a potentially escalating or unresolved user interaction such that he/she may intervene and assist the frontline agent or takeover the user interaction. Thus, the escalation alerts may provide a means for automatically determining when intervention by another party, such as a security officer, manager, supervisor, etc., is required without relying on the frontline agent, who may be preoccupied with the user, to do so.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used generating and providing emotionally intelligent interaction guidance.

FIG. 2 illustrates a schematic block diagram of example circuitry embodying a system device that may perform various operations in accordance with some example embodiments described herein.

FIGS. 3A-3B illustrates an example flowchart for generating and providing emotionally intelligent interaction guidance, in accordance with some example embodiments described herein.

FIG. 4 illustrates an example flowchart for determining an inferred emotional classification for the user, in accordance with some example embodiments described herein.

FIG. 5 illustrates an example flowchart for generating emotionally intelligent interaction guidance, in accordance with some example embodiments described herein.

FIG. 6 illustrates an example flowchart for responding to an escalation event, in accordance with some example embodiments described herein.

FIG. 7 illustrates an example machine learning model framework, as used in accordance with some embodiments described herein.

FIGS. 8A, 8B, and 8C illustrate an example user interface depicting emotionally intelligent interaction guidance, as used in some example embodiments described herein.

FIGS. 9 and 10 illustrate examples of a user interface depicting escalation alerts, as used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers, programmable automation controllers, industrial computers, desktop computers, personal data assistants, laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

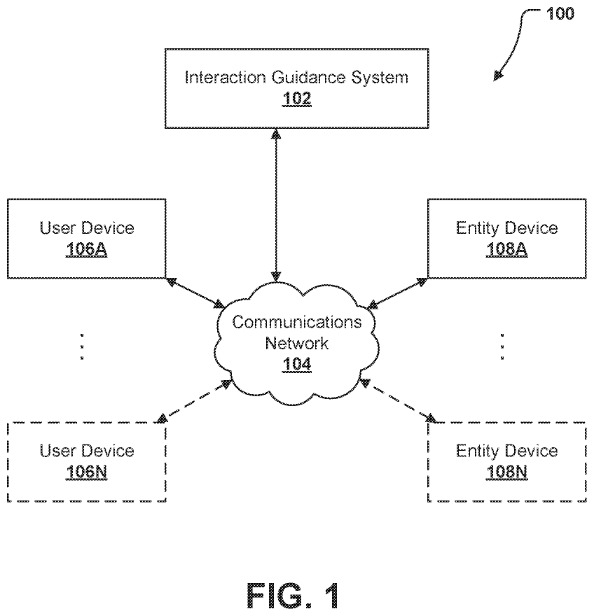

Example embodiments described herein may be implemented using any of a variety of computing devices or servers. To this end, FIG. 1 illustrates an example environment 100 within which various embodiments may operate. As illustrated, an interaction guidance system 102 may receive and/or transmit information via communications network 104 (e.g., the Internet) with any number of other devices, such as one or more of user devices 106A-106N and/or entity devices 108A-108N.

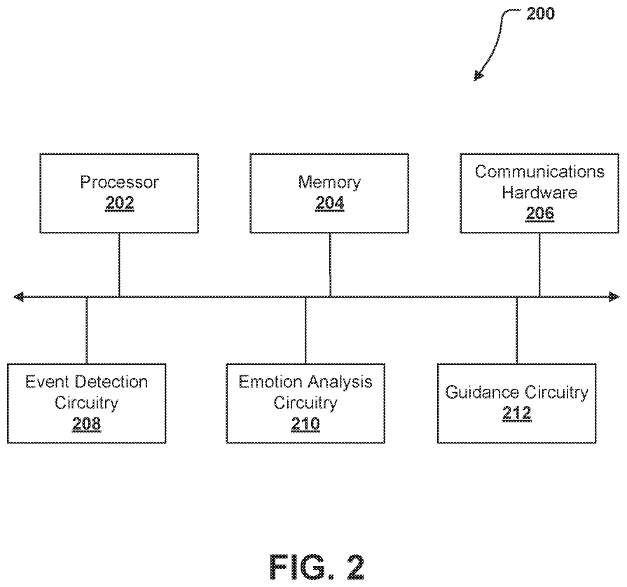

The interaction guidance system 102 may be implemented as one or more computing devices or servers, which may be composed of a series of components. Particular components of the interaction guidance system 102 are described in greater detail below with reference to apparatus 200 in connection with FIG. 2.

In some embodiments, the interaction guidance system 102 further includes a storage repository (not shown) that comprises a distinct component from other components of the interaction guidance system 102. The storage repository may be embodied as one or more direct-attached storage devices (such as hard drives, solid-state drives, optical disc drives, or the like) or may alternatively comprise one or more Network Attached Storage devices independently connected to a communications network (e.g., communications network 104). In some embodiments, the storage repository may host the software executed to operate the interaction guidance system 102. The storage repository may store information relied upon during operation of the interaction guidance system 102, such as various models (e.g., pre-processing models, emotional intelligence machine learning models, guidance machine learning models, and/or the like), data sets (e.g., machine learning training data sets, and/or the like) that may be used by the interaction guidance system 102, data and documents to be analyzed using the interaction guidance system 102, or the like. In addition, the storage repository may store control signals, device characteristics, and access credentials enabling interaction between the interaction guidance system 102 and one or more of the user devices 106A-106N or entity devices 108A-108N.

The one or more user devices 106A-106N and the one or more entity devices 108A-108N may be embodied by any computing devices known in the art. The one or more user devices 106A-106N and the one or more entity devices 108A-108N need not themselves be independent devices but may be peripheral devices communicatively coupled to other computing devices. In some embodiments, the one or more user devices 106A-106N are associated with a user, such as a customer of an institution or a visitor within an environment. In some embodiments, the one or more entity devices 108A-108N are associated with the institution. In some embodiments, the one or more entity devices 108A-108N may be associated with a particular environment. For example, one or more of the one or more entity devices may be cameras, radars, sensors (e.g., thermal sensors, IR sensors, motion sensors, ultrasonic sensors, galvanic sensors, near-field communication (NFC) sensors, Bluetooth sensors, and/or the like), controllers (e.g., temperature controller, lighting controller, fans, ducts, and/or the like), speakers, audio capture devices, displays, interaction terminals, etc.

Although FIG. 1 illustrates an environment and implementation in which the interaction guidance system 102 interacts indirectly with a user via one or more of user devices 106A-106N and/or entity devices 108A-108N, in some embodiments users may directly interact with the interaction guidance system 102 (e.g., via communications hardware of the interaction guidance system 102), in which case a separate user device 106A-106N and/or entity device 108A-108N may not be utilized. Whether by way of direct interaction or indirect interaction via another device, a user may communicate with, operate, control, modify, or otherwise interact with the interaction guidance system 102 to perform the various functions and achieve the various benefits described herein.

### Example Implementing Apparatuses

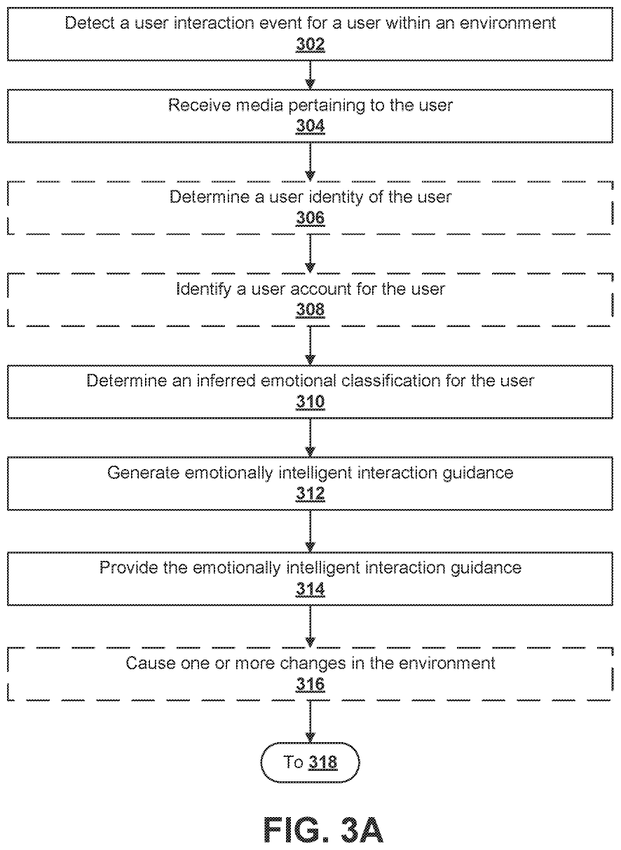

The interaction guidance system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3A-6. As illustrated in FIG. 2, the apparatus 200 may include processor 202, memory 204, communications hardware 206, event detection circuitry 208, emotion analysis circuitry 210, and guidance circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, desktop application, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises event detection circuitry 208 that is configured to detect a user interaction event for a user within an environment, determine a user identity based on the received media, and identify a use account for the user. The event detection circuitry 208 may utilize processor 202, memory 204, or any other hardware component included in the apparatus 200 to perform these operations, as described in connection with FIGS. 3A-6 below. The event detection circuitry 208 may further utilize communications hardware 206 to gather data from a variety of sources (e.g., user devices 106A-106N, entity device 108A-108N, as shown in FIG. 1).

In addition, the apparatus 200 further comprises emotion analysis circuitry 210 that is configured to determine an inferred emotional classification for the user. The emotion analysis circuitry 210 may further extract one or more user characteristics from the received media, determine a probability for one or more candidate emotional classifications, and determine a probability for one or more candidate core emotions. The emotion analysis circuitry 210 may utilize processor 202, memory 204, or any other hardware component included in the apparatus 200 to perform these operations, as described in connection with FIGS. 3A-6 below. The emotion analysis circuitry 210 may further utilize communications hardware 206 to gather data from a variety of sources (e.g., user devices 106A-106N, entity device 108A-108N, as shown in FIG. 1).

Further, the apparatus 200 further comprises guidance circuitry 212 that is configured to generate the emotionally intelligent guidance. The guidance circuitry may also be configured to determine a user action request, determine one or more candidate actions, determine an inferred emotional responsiveness classification, select one or more candidate actions, determine an escalation event, and generate an escalation alert. The guidance circuitry 212 may utilize processor 202, memory 204, or any other hardware component included in the apparatus 200 to perform these operations, as described in connection with FIGS. 3A-6 below. The guidance circuitry 212 may further utilize communications hardware 206 to gather data from a variety of sources (e.g., user devices 106A-106N, entity device 108A-108N, as shown in FIG. 1).

Although components 202-212 are described in part using functional language, it will be understood that the particular implementations necessarily include the use of particular hardware. It should also be understood that certain of these components 202-212 may include similar or common hardware. For example, the event detection circuitry 208, emotion analysis circuitry 210, and guidance circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the event detection circuitry 208, emotion analysis circuitry 210, and guidance circuitry 212 may leverage processor 202, memory 204, or communications hardware 206 as described above, it will be understood that any of event detection circuitry 208, emotion analysis circuitry 210, and guidance circuitry 212 may include one or more dedicated processor, specially configured field programmable gate array, or application specific interface circuit to perform its corresponding functions, and may accordingly leverage processor 202 executing software stored in a memory (e.g., memory 204), or communications hardware 206 for enabling any functions not performed by special-purpose hardware. In all embodiments, however, it will be understood that event detection circuitry 208, emotion analysis circuitry 210, and guidance circuitry 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of graphical user interfaces and flowcharts.

### Example Operations

Turning to FIGS. 3A-6, example flowcharts are illustrated that contain example operations implemented by example embodiments described herein. The operations illustrated in FIGS. 3A-6 may, for example, be performed by system device of interaction guidance system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, event detection circuitry 208, emotion analysis circuitry 210, and guidance circuitry 212, and/or any combination thereof. It will be understood that user interaction with the interaction guidance system 102 may occur directly via communications hardware 206 or may instead be facilitated by a separate user device (e.g., any one of user devices 106A-106N) and/entity device (e.g., any one of entity devices 108A-108N), as shown in FIG. 1, and which may have similar or equivalent physical componentry facilitating such user interaction.

Turning first to FIGS. 3A-3B, example operations are shown for generating and providing emotionally intelligent guidance.

As shown by operation 302, the apparatus 200 includes means, such as processor 202, memory 204, communications hardware 206, event detection circuitry 208, or the like, for detecting a user interaction event for a user within an environment. In some embodiments, the event detection circuitry 208 may be configured to detect a user interaction event for a user in response to a user physically entering into the environment. By way of particular example, the event detection circuitry 208 may be configured to detect that a user has entered an environment, such as a branch of a financial institution. The environment may be a physical environment that is associated with a predefined geographic area. The predefined geographic area may be any suitable shape, size, area, or the like. In some embodiments, the predefined geographic area may be stored in an associated memory, such as memory 204 or the like. Thus, the event detection circuitry 208 may access the associated memory to determine the predefined geographic area for the environment. By way of continuing example, an environment that is a branch of a financial institution may have a predefined geographic area that includes the physical building, such as lobbies, rooms, entryways, exits, etc. and in some embodiments, adjacent sidewalks and/or parking lots.

The event detection circuitry 208 may be configured to detect that user interaction event in a variety of ways. In some embodiments, communications hardware 206 may receive data from one or more entity devices (e.g., any one of entity devices 108A-108N) and the event detection circuitry 208 may detect that a user has entered the environment from the received data. For example, an entity device may be a motion sensor that is setup by an entryway to detect a user presence. The communications hardware 206 may receive data from the entity device indicative that motion has been detected in the entryway in response to a user entering the environment through the entryway. As another example, the entity device may be a camera configured to detect a user presence within the environment. The communications hardware 206 may receive data from the entity device in the form of captured images and/or a video in response to detection of a user presence within the environment. As yet another example, the entity device may be an NFC sensor, Bluetooth sensor, or the like such that the entity device may detect a user device that is within a predefined proximity. Thus, communications hardware 206 may receive data from the entity device indicative that a user device has been detected, and in some embodiments, details pertaining to the user device, in response to detection of a user device within the predefined proximity of the entity device.

In some embodiments, the event detection circuitry 208 may be configured to detect the user interaction event in response to the communications hardware 206 receiving data from the entity devices (e.g., any one of entity devices 108A-108N). For example, if the received data is from a motion sensor and the communications hardware 206 receives data indicative of activity detected by the motion sensor, the event detection circuitry 208 may be configured to automatically detect the user interaction event upon receipt of the received data from the entity device.

Additionally, or alternatively, the event detection circuitry 208 may be configured to process the data to detect the user interaction event. For example, in some embodiments, the signal may include captured images and/or data that require additional processing by the event detection circuitry 208 to detect a user interaction event. In some embodiments, the event detection circuitry 208 may use one or more user detection models to detect the user interaction event. A user detection model may be a rules-based model or machine learning model that is trained to process the received data and output an indication of whether a user interaction event is detected (e.g., a classification of “user interaction event” or “no user interaction event”, a Boolean value of “true” or “false”, and/or the like). In some embodiments, the user detection model may use one or more image processing techniques, such as object detection techniques, to identify users within the data (e.g., images and/or videos). Alternatively, the user detection model may use other text-based data processing techniques.

In some embodiments, the user detection model may further be configured to ignore certain users and/or user devices. By way of continuing example, if the environment is a branch of a financial institution, the user detection model may determine whether a detected user corresponds to an excluded user or user device. For example, in some embodiments, an excluded user list may be stored and/or maintained in an associated memory, such as memory 204. The excluded user list may be managed by one or more authorized users, such as administrators of apparatus 200. Each excluded user in the excluded user list may be associated with a user image (e.g., an image depicting the employee's face), user device information (e.g., a user device identifier, a user device serial number, a phone number, international mobile equipment identifier (IMEI), and/or the like), user information (e.g., employee badge information), and/or other user information. The user detection model may use this excluded user list to exclude consideration of these users such that the event detection circuitry 208 may not detect a user interaction event for these users. By way of particular example, the event detection circuitry 208 may use the user detection model to determine whether a user captured in a received image and/or video (e.g., received data) corresponds or matches the image for an excluded user. As another example, the event detection circuitry 208 may determine whether the received data is includes user device information that corresponds to user device information for an excluded user. In an instance in which the event detection circuitry 208 determines the received information does correspond to an excluded user, the event detection circuitry 208 may not determine a user interaction event. Thus, the event detection circuitry 208 may conserve computational resources by intelligently filtering out data indicative of excluded users such that the event detection circuitry does not detect user interaction events for these excluded users.

In some embodiments, the event detection circuitry 208 and/or the user detection model may be configured to consider received information pertaining to a same user in aggregate. For example, the event detection circuitry 208 may use temporal information associated with received data to determine received data that corresponds to the same user. By way of particular example, the event detection circuitry 208 may determine that data received from a first entity device (e.g., entity device 108A that may be a motion sensor), data received from a second entity device (e.g., entity device 108B that may be a camera), and data received from a third entity device (e.g., entity device 108C that may be a Bluetooth sensor) are associated with temporal data indicative of the events happening within a threshold time from one another (e.g., within 1 second, within 10 seconds, within the same minute, or the like) and thus, event detection circuitry 208 may determine the received data is associated with the same user. Thus, the event detection circuitry 208 conserves computational resources by consideration of multiple instances of the data corresponding to the same user together, thereby eliminating redundant instances of user interaction event detection.

As shown by operation 304, the apparatus 200 includes means, such as processor 202, memory 204, communications hardware 206, event detection circuitry 208, or the like, for receiving media pertaining to the user. Once the event detection circuitry 208 has detected a user interaction event, the communications hardware 206 may receive media pertaining to the user. In some embodiments, the communications hardware 206 may receive media pertaining to the user in regular intervals or continuously from one or more entity devices (e.g., any one or entity devices 108A-108N). The received media may be of any suitable format. For example, the received media may be an image file, a video file, an audio file, a text file, compressed files, general purpose files, executable files, cloud-sharing files, and/or the like. Additionally, the received media may be of any suitable extension. The received media pertaining to the user may be indicative of text data, audio data, image data, physiological data (e.g., heart rate, body temperature, perspiration, galvanic skin response, eye activity, blood pressure, motion analysis, perspiration, and/or the like) and/or the like that pertains to the user. In some embodiments, the event detection circuitry 208 may use a speech-to-text algorithm to generate a transcript for the user from received audio media. The resulting transcript may be considered as text media pertaining to the user.

In some embodiments, in response to detection of a user interaction event, the communications hardware 206 may request media from one or more entity devices (e.g., any one of entity devices 108A-108N). In some embodiments, some entity devices may provide data and/or media only upon request from the communications hardware 206. For example, entity devices such as an IR sensor, galvanic sensor, etc. may be relevant only during user interaction events. Thus, these entity devices may not be configured to regularly transmit media or data but may do so upon request from the communications hardware 206. Thus, the communications hardware 206 may be configured to provide this request or signal to these one or more entity devices. The communications hardware 206 may then receive media pertaining to the user from the one or more entity devices.

In some embodiments, the event detection circuitry 208 may process the received media to determine whether the media pertains to the user. In some embodiments, the event detection circuitry 208 may use a user detection machine learning model to determine whether the received media pertains to the user. The user detection machine learning model may be a trained machine learning model, such as a convolutional neural network (CNN) or a CNN variant (e.g., a region-based CNN (R-CNN), fast R-CNN, faster R-CNN). The user detection machine learning model may be trained to detect objects within images (e.g., image media) and classify the object as the user or not the user. The user detection machine learning model may be trained on a corpus of images of various users. The user detection machine learning model may be trained to target a particular user and identify this user within various images. The user detection machine learning model may include convolutional layers configured to extract features from each image, pooling layers to account for spatial dimensions of the extracted features, and optionally, fully connected layers to classify the extracted features (e.g., target user or not target user). In some embodiments, the user detection machine learning model may also be configured with a predefined location and/or coordinate system and trained to output the relative location of a detected user. For example, the user detection machine learning model may be configured to process a series of images, identify whether a target user is within the images, and if the user is within the images, use the predefined location to determine a location of the user (e.g., nearby an entryway, at the counter, at relative coordinates (12, 4), and/or the like).

In some embodiments, the user detection machine learning model may provide images and/or video determined to pertain the user and, in some embodiments, a location of the user to the event detection circuitry 208. The event detection circuitry 208 may then determine other received media pertaining to the user based on the location of the user. For example, the event detection circuitry 208 may be configured with the location of the one or more entity devices (e.g., entity devices 108A-108N) and determine whether the user location is within detection range of an entity device. If the user location is within detection range of an entity device, the event detection circuitry 208 may determine the media pertains to the user. Otherwise, the event detection circuitry 208 may determine the media does not pertain to the user and may ignore the received media. In this way, the event detection circuitry 208 may consider multiple sources of media while filtering out irrelevant media (e.g., media that does not pertain to the user), thus conserving computational resources expended to subsequently process the media.

Optionally, as shown by operation 306, the apparatus 200 includes means, such as processor 202, memory 204, event detection circuitry 208, or the like, for determining a user identity of the user. In some embodiments, the event detection circuitry 208 may further determine the user identity of the user. In some embodiments, the user may provide an indication of his/her identity, such as via biometric scan (e.g., facial scan, retina scan, fingerprint scan), or an image depicting the user may be captured such that the user does not need to provide this. Biometric scans and/or images of the user may be captured in the received media. The event detection circuitry 208 may then use any suitable techniques, such as image recognition techniques, biometric authentication techniques, and/or the like to identify the user. In particular, the event detection circuitry 208 may compare the captured scans and/or images to biometric and/or image data associated with one or more user accounts maintained by apparatus 200. In an instance that a corresponding scan and/or image is identified in a user account (e.g., the comparison resulted in a similarity score that satisfies a similarity score threshold), the event detection circuitry 208 may determine the user identity to correspond to the user identity indicated by the user account. In an instance that no user account with a corresponding scan and/or image is detected, the event detection circuitry 208 may fail to determine the user identity of the user. This may be due to insufficient media (e.g., blurry images, poor scan or image quality, incorrect capture angle, poor lighting, or the like) sufficient to determine a similarity score that satisfies a similarity score threshold or because the user does not have a user account associated with apparatus 200.

Optionally, as shown by operation 308, the apparatus 200 includes means, such as processor 202, memory 204, event detection circuitry 208, or the like, for identifying a user account for the user. As described above, the event detection circuitry 208 may determine compare the image or scans pertaining to the user with images, scans, or biometric data associated with a user account. In an instance that a corresponding scan and/or image is identified in a user account (e.g., the comparison resulted in a similarity score that satisfies a similarity score threshold), the event detection circuitry 208 may determine the user identity of the user. The event detection circuitry 208 may also identify this user account as the user account for the user. In some embodiments, user account may include information pertaining to the user. For example, the user account may include user information (e.g., name, preferred name/nickname, residential address, phone number, email address, and/or the like), user device information (e.g., trusted user device identifiers, user device IMEIs, user device serial numbers, and/or the like), financial information (e.g., account numbers, account balances, historical transactions, and/or the like), user preferences (e.g., preferred pronouns, preferred greetings, preferred suffix, and/or the like), known user life events, historical user interaction events, and/or the like.

As shown by operation 310, the apparatus 200 includes means, such as processor 202, memory 204, emotion analysis circuitry 210, or the like, for determining an inferred emotional classification for the user. The emotion analysis circuitry 210 may determine the inferred emotional classification for the user based on the received media that pertains to the user. An inferred emotional classification may be associated with a probability that the user possesses an emotion corresponding to the inferred emotional classification. In some embodiments, the emotion analysis circuitry 210 may use an emotional intelligence machine learning model to determine the inferred emotional classification for the user.

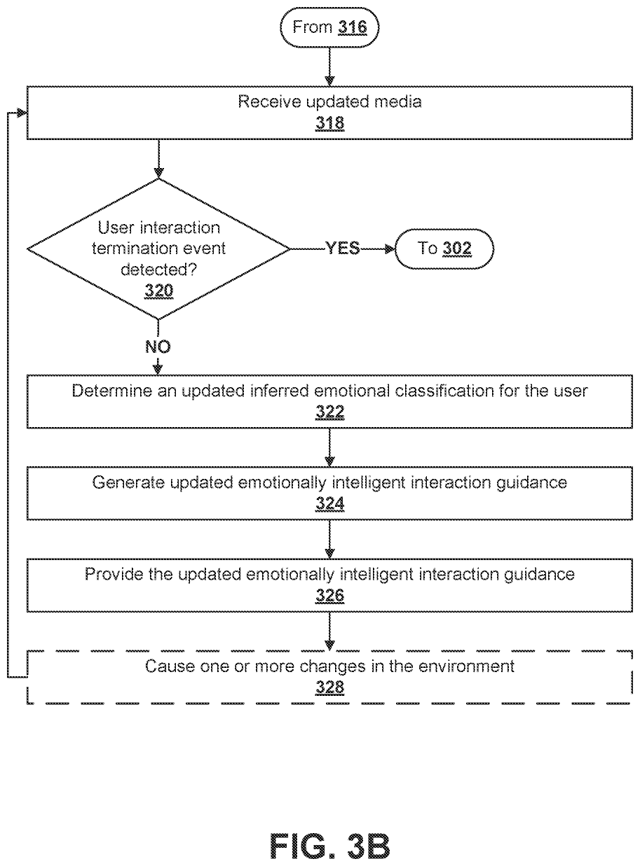

The emotional intelligence machine learning model may be a trained machine learning model or deep learning model configured to determine a probability for one or more candidate emotional classifications and determine an inferred emotional classification for the user. In some embodiments, the emotional intelligence machine learning model is a deep neural network (DNN). In some embodiments, the emotional intelligence machine learning model may be configured to process the received media pertaining to the user itself and extract one or more user characteristics (e.g., a user facial expression, user body language, a user gesture, a user voice tone, a user voice volume, a user speech speed, a user speech patterns, user eye contact behavior, user physiological responses, user speech text, and/or the like) from the media. Alternatively, the emotional intelligence machine learning model may receive one or more user characteristics from a preprocessing model. In some embodiments, the emotional intelligence machine learning model may process different types of user characteristics and determine a probability for each candidate emotional classification based on the various types of user characteristics. Further details regarding the extraction of user characteristics and determination of probability for a candidate emotional classification will be described in FIG. 4. Additionally, in some embodiments, the emotional intelligence machine learning model may be a multimodal model that is configured to process user characteristics in different types or formats (e.g., text data, audio data, image data, physiological data, and/or the like). In some embodiments, the emotional intelligence machine learning model may apply fusion-based approaches (e.g., early fusion, late fusions, or hybrid fusion) and/or joint representation learning techniques to handle the various formats of data.

The emotional intelligence machine learning model may be trained using supervised learning techniques. For example, in some embodiments an emotion corpus may be used to train the emotional intelligence machine learning model. The emotion corpus may include a plurality of user characteristics in various formats (e.g., text data, audio data, image data, physiological data, and/or the like) and each user characteristic may be labelled or tagged with an inferred emotional classification as applied by a subject matter expert. For example, a user characteristic may be an image that depicts the user's facial expression. The emotional intelligence machine learning model may be provided this user characteristic and may be trained to apply image processing techniques, such as facial emotion recognition (FER) techniques and/or the like, to process the user characteristic and determine an inferred emotional classification. As another example, a user characteristic may be an audio file of the user's voice tone, voice volume, voice pitch, voice speed, and/or the like. Here, the emotional intelligence machine learning model may be provided this user characteristic and may be trained to apply audio processing techniques, such as speech emotion recognition (SER) and/or the like, to process the user characteristic and determine an inferred emotional classification. As another example, a user characteristic may be a text file of transcribed user speech. Here, the emotional intelligence machine learning model may be provided this user characteristic and may be trained to apply natural language processing (NLP) techniques and/or sentiment analysis techniques to process the user characteristic and determine an inferred emotional classification. As yet another example, a user characteristic may be physiological data (e.g., heart rate, thermal temperature, galvanic skin response, eye activity, blood pressure, motion analysis, perspiration, etc.). The physiological data may be labelled with an inferred emotional classification. Here, the emotional intelligence machine learning model may be provided this user characteristic and may be trained to apply various comparative processing techniques, such as various mathematical and/or logical operations, to process the user characteristic and determine an inferred emotional classification. By way of particular example, the emotional intelligence machine learning model may be configured to compare various physiological response values to one or more baseline physiological response values to determine an inferred emotional classification.

Any suitable training techniques may then be used, such determining the loss or error based on a comparison of the ground-truth inferred emotional classification and the inferred emotional classification determined by the emotional intelligence machine learning model. In some embodiments, the error is also determined based on whether the emotional intelligence machine learning model identified the annotated terms in the user characteristic. Backpropagation may then be applied to determine the gradient of the loss function across the emotional intelligence machine learning model layers. The parameter weights for the emotional intelligence machine learning model may be updated during this process and the forward pass and backpropagation phase may be repeated until the loss is optimized or minimized.

Alternatively, the emotional intelligence machine learning model may be trained using an unsupervised or semi-supervised learning techniques. Like in supervised learning techniques, an emotion corpus may be used to train the emotional intelligence machine learning model. However, for an unsupervised learning method, the emotion corpus may include a plurality of user characteristics in various formats (e.g., text data, audio data, image data, physiological data, and/or the like) but the included user characteristics may not be labelled or tagged with inferred emotional classifications. Instead, the emotional intelligence machine learning model may be configured to infer patterns within the user characteristics, such as through clustering techniques (e.g., K-means, density-based spatial clustering of applications (DBSCAN), hierarchical clustering, and/or the like), dimensionality reduction techniques (e.g., principal component analysis (PCA), T-distributed stochastic neighbor embedding (t-SNE), autoencoders, and/or the like), using association rule learning algorithms, and/or via using generative models (e.g., generative adversarial networks (GANs), variational autoencoders, and/or the like).

In some embodiments, reinforcement learning may be used to fine-tune the emotional intelligence machine learning model, which has been trained using supervised, semi-supervised, or unsupervised learning techniques. For example, the emotional intelligence machine learning model may be configured to output an inferred emotional classification for a user characteristic and a user may review and provide feedback to the emotional intelligence machine learning model. The feedback may be indicative of whether the emotional intelligence machine learning model correctly determined the inferred emotional classification for the user characteristic. If the emotional intelligence machine learning model did not determine the correct inferred emotional classification, the feedback may further include the correct emotional classification for the user characteristic. Thus, the emotional intelligence machine learning model may be fine-tuned using user feedback, thereby resulting in a more accurate model.

In some embodiments, the emotion analysis circuitry 210 may determine a probability for a plurality of candidate emotional classifications using the emotional intelligence machine learning model. The emotional intelligence machine learning model may determine the inferred emotional classification for the user based on the probability associated with each candidate emotional classification. For example, the emotional intelligence machine learning model may determine an 85 percent probability for an “frustrated” candidate emotional classification, a 10 percent probability for a “worried” candidate emotional classification, a 5 percent probability for a “disappointed” candidate emotional classification, and negligible or a 0 percent probability for other candidate emotional classifications. The emotional intelligence machine learning model may then perform one or more mathematical and/or logical operations to determine the inferred emotional classification for the user. For example, the emotional intelligence machine learning model may be configured to select the candidate emotional classification associated with the greatest probability. As another example, the emotional intelligence machine learning model may be configured to select the candidate emotional classification associated with the greatest probability only if the associated probability satisfies one or more probability thresholds.

In some embodiments, operation 310 may be performed in accordance with the operations described by FIG. 4. Turning now to FIG. 4, example operations are shown for determining an inferred emotional classification based on a probability for one or more candidate emotional classifications.

As shown by operation 402, the apparatus 200 includes means, such as processor 202, memory 204, emotion analysis circuitry 210, or the like, for extracting one or more user characteristics from the received media. A user characteristic may be data representative of a particular feature of the user. For example, a user characteristic may be a user facial expression, user body language, a user gesture, a user voice tone, a user voice volume, a user speech speed, a user speech patterns, user eye contact behavior, user physiological responses, user speech text, and/or the like. In some embodiments, individual user characteristics may be extracted from the received media. The particular format of the extracted user characteristics may be dependent upon the type of media a given user characteristic is extracted from. In some embodiments, a user characteristic may be formatted as numerical vectors, arrays, or tensors, key points and descriptors, and/or the like for media that is an image, video, or audio. In some embodiments, a user characteristic may be formatted as a feature vector, sparse matrix, embedding, and/or the like for text media. Regardless of the format of the user characteristic, the extraction of the user characteristic may transform raw data (e.g., structured or unstructured media) into structured data that can be subsequently processed by the emotional intelligence machine learning model.

In some embodiments, the emotion analysis circuitry 210 may use a preprocessing model to extract the one or more user characteristics. A preprocessing model may be configured to transform raw data (e.g., the received media) into structured user characteristics. In some embodiments, the preprocessing model may be configured to handle different data (e.g., media) formats. Alternatively, multiple preprocessing models may be used to generate the one or more user characteristics. Additionally, a preprocessing model may be configured to normalize, standardize, and otherwise handle data values within the media. In some embodiments, a preprocessing model may be configured to remove stop words and/or lemmatize from text media. Additionally, or alternatively, the preprocessing model may be configured to tokenize and/or vectorize text media to transform the text media into a feature vector, sparse matrix, embedding, and/or the like to generate the corresponding user characteristic. In some embodiments, a preprocessing model may be configured to transform or otherwise augment image and/or video media. The preprocessing model may further be configured to transform a portion of an image and/or video media by converting it to numerical vectors, arrays, or tensors, key points and descriptors, and/or the like to generate the corresponding user characteristic.

Once the preprocessing model has received and processed the media, it may output the generated user characteristics to the emotional intelligence machine learning model. Alternatively, in some embodiments, the emotion analysis circuitry 210 may input the media directly to the emotional intelligence machine learning model and the emotional intelligence machine learning model may be configured to perform any or all of the above-described preprocessing operations to transform the media into one or more user characteristics.

Optionally, as shown by operation 404, the apparatus 200 includes means, such as processor 202, memory 204, emotion analysis circuitry 210, or the like, for determining a probability for one or more candidate core emotions for each user characteristic. In some embodiments, the emotion analysis circuitry 210 may be configured to determine a probability for one or more candidate core emotions for each user characteristic prior to determining a probability for one or more candidate emotional classifications. A candidate core emotion may describe a subset of emotions. In particular, a candidate core emotion may be a basic or primary emotion. Candidate core emotions may be characterized by distinct user characteristics (e.g., facial expression, body language, speech, physiological responses) that may be fundamental or consistent across various populations, cultures, and demographics. In some embodiments, candidate core emotions include happiness, sadness, fear, disgust, anger, and surprise.

In some embodiments, the emotion analysis circuitry 210 may use the emotional intelligence machine learning model to determine the probability for the one or more candidate core emotions. In some embodiments, the emotional intelligence machine learning model may be configured with the set of candidate core emotions and trained to recognize the user characteristics associated with each candidate core emotion. Thus, the emotional intelligence machine learning model may process the one or more user characteristics and generate a probability for each of the one or more candidate core emotions. For example, the emotional intelligence machine learning model may process user characteristics representative of the user's frown and tense facial features, mild speech volume, and arms crossed (e.g., body language) and determine an 80 percent probability for the anger candidate core emotion, a 10 percent probability for the sadness candidate core emotion, an 8 percent probability for the disgust candidate core emotion, a 1 percent probability for the fear candidate core emotion, and a less than 1 percent probability for the remaining candidate core emotions.

As shown by operation 406, the apparatus 200 includes means, such as processor 202, memory 204, emotion analysis circuitry 210, or the like, for determining a probability for one or more candidate emotional classifications. The emotion analysis circuitry 210 may determine a probability for the one or more candidate emotional classifications using the emotional intelligence machine learning model. In some embodiments, the emotional intelligence machine learning model may be configured with candidate emotional classifications, which may include all possible emotional classifications that may be determined for a given user. The candidate emotional classifications may include the candidate core emotions as well as other, more complex emotions. More complex emotions may describe emotions that may be lack consistency in their expression across various populations, cultures, and demographics. For this reason, it may be beneficial to first determine a probability for the one or more candidate core emotions prior to determining a probability for the one or more candidate emotional classifications.

In some embodiments, a candidate core emotional classification that is not a candidate core emotion may be associated with or related to a particular candidate core emotion. For example, candidate emotional classifications may include happiness, sadness, fear, disgust, anger, surprise, scared, anxious, insecure, guilty, despair, lonely, bored, disappointed, joyful, peaceful, excited, confused, frustrated, aggressive, and/or the like. By way of continuing example, the candidate emotional classifications of anxious and insecure may be associated with the fear candidate core emotion; guilty, despair, lonely, and bored may be associated with the sad candidate core emotion; disappointed may be associated with the disgust candidate core emotion; joyful and peaceful may be associated with the happy candidate core emotion; excited and confused may be associated with the surprise candidate core emotion; and frustrated and aggressive may be associated with the anger candidate core emotion. It will be appreciated that other candidate emotional classifications may be contemplated.

In some embodiments, in an instance in which a probability was determine for each of the one or more candidate core emotions, the emotional intelligence machine learning model may be configured to determine the top n candidate core emotions associated with the most likely probability. In some embodiments, the emotional intelligence machine learning model may only select one candidate core emotion. Alternatively, the emotional intelligence machine learning model may determine whether the probability for a given candidate core emotion satisfies one or more probability thresholds. In an instance the probability for a candidate core emotion does satisfy the one or more probability thresholds, the emotional intelligence machine learning model may select the candidate core emotion. In this way, the emotional intelligence machine learning model may select more than one candidate core emotion.

Once the emotional intelligence machine learning model has selected the n candidate core emotions, the emotional intelligence machine learning model may restrict consideration of the candidate emotional classifications to include one the n candidate core emotions and candidate emotional classifications associated with the n candidate core emotions. By way of continuing example, the emotional intelligence machine learning model may be configured with a probability threshold of 10 percent or greater. Thus, the emotional intelligence machine learning model may select the anger candidate core emotion (e.g., associated with an 80 percent probability) and sadness candidate core emotion (e.g., associated with a 10 percent probability). The emotional intelligence machine learning model may then restrict consideration of candidate emotional classifications to only sad, guilty, despair, lonely, bored, angry, and frustrated.

Alternatively, the emotional intelligence machine learning model may skip determining a probability for the one or more candidate core emotions and proceed directly to determining a probability for the one or more candidate emotional classifications. In either case, the emotional intelligence machine learning model may process the user characteristics, either individually or simultaneously such as by leveraging parallel processing techniques. The emotional intelligence machine learning model may then determine a probability for each of the one or more candidate emotional classifications based on the user characteristics. By way of continuing example, the emotional intelligence machine learning model may determine a 65 percent probability for the frustrated candidate emotional classification, a 33 percent probability for the angry candidate emotional classification, and a less than one percent probability for the remaining candidate emotional classifications (e.g., sad, guilty, despair, lonely, and bored).

As shown by operation 408, the apparatus 200 includes means, such as processor 202, memory 204, emotion analysis circuitry 210, or the like, for determining the inferred emotional classification based on the corresponding probability for the one or more candidate emotional classifications. The emotion analysis circuitry 210 may use the emotional intelligence machine learning model to determine the inferred emotional classification for the user. In particular, once the emotional intelligence machine learning model has determined a probability for the one or more candidate emotional classifications, the emotional intelligence machine learning model may determine an inferred emotional classification for the user based on each determined probability.

The emotional intelligence machine learning model may then perform one or more mathematical and/or logical operations to determine the inferred emotional classification for the user. For example, the emotional intelligence machine learning model may be configured to select the candidate emotional classification associated with the greatest probability. By way of continuing example, the emotional intelligence machine learning model may be configured to select the frustrated candidate emotional classification. Additionally, or alternatively, the emotional intelligence machine learning model may be configured to select the candidate emotional classification associated with the greatest probability only if the associated probability satisfies one or more probability thresholds. The emotional intelligence machine learning model may output the inferred emotional classification determined for the user to the emotion analysis circuitry 210.

By way of continuing example, the emotional intelligence machine learning model may be configured with a threshold of 70 percent or greater. Thus, the emotional intelligence machine learning model would determine that the probability of 65 percent for the frustrated candidate emotional classification (and the probabilities associated with the other candidate emotional classifications) would fail to satisfy the probability threshold. In this instance, the emotional intelligence machine learning model may fail to determine any inferred emotional classification. Thus, the probability threshold may be used as a quality control safeguard to prevent the emotional intelligence machine learning model from determining an incorrect inferred emotional classification.

Alternatively, the emotional intelligence machine learning model may be configured with a threshold of 20 percent or greater such that the probabilities for both the frustrated candidate emotional classification and angry candidate emotional classification satisfy the probability threshold. Here, the emotional intelligence machine learning model may compare the probabilities between the two candidate emotional classifications and select the candidate emotional classification associated with the greater probability. Thus, in this instance, the emotional intelligence machine learning model may select the frustrated candidate emotional classification and therefore determine a frustrated inferred emotional classification for the user.

Returning now to FIG. 3A, as shown by operation 312, the apparatus 200 includes means, such as processor 202, memory 204, guidance circuitry 212, or the like, for generating emotionally intelligent interaction guidance. Once the emotion analysis circuitry 210 has determined an inferred emotional classification for the user, it may provide the inferred emotional classification to the guidance circuitry 212. The guidance circuitry 212 may then generate emotionally intelligent interaction guidance for one or more users based on the inferred emotional classification. In some embodiments, the generated emotionally intelligent interaction guidance is indicative of the inferred emotional classification determined for the user and one or more recommended actions for interacting with the user. For example, the one or more recommended actions may include physical, verbal, and/or auditory cues that may be used to facilitate and/or enhance user interaction.

In some embodiments, the emotionally intelligent interaction guidance may be generated for and provided to a frontline agent who is interacting with the user. For example, the user may be visiting a branch of a financial institutional and may interact with the frontline agent, who may be an employee of financial institution. Thus, the frontline agent may be required to interact with the user and aid them in their requests. Here, the emotionally intelligent interaction guidance may be provided to the frontline agent such that the frontline agent may automatically be provided with the inferred emotional classification of the user. Additionally, the emotionally intelligent interaction guidance may provide recommended actions that the frontline agent may take to facilitate a more pleasant user interaction between the frontline agent and the worker. For example, the emotionally intelligent interaction guidance may include recommended actions to make eye contact with the user and greet him/her. Additionally, the recommended actions may include an offer to aid the user with any issues he/she may be experiencing. In this way, the frontline agent may be provided with convenient mechanisms to enhance the user experience, which may be particularly useful as frontline agents experience high volumes of user interactions of varying emotional intensities each day.

In some embodiments, the guidance circuitry 212 may generate the emotionally intelligent interaction guidance using a guidance machine learning model. In some embodiments, the guidance machine learning model is a trained machine learning model or deep learning model that is configured to process the inferred emotional classification for a user and in some embodiments, a user action request, and generate the emotionally intelligent interaction guidance. In some embodiments, the guidance machine learning model is a DNN or a large language model (LLM). The guidance machine learning model may be trained using an unsupervised learning approach. In some embodiments, a base model (e.g., a base DNN or base LLM) model may be initialized. The base model may then be provided training emotionally intelligent interaction guidance from training guidance corpus. The training guidance corpus may include various training guidance, which may include transcripts from real interactions between frontline agents and users, manuals or other literature describing appropriate handling of various user interactions based on user emotional states, and/or the like. In some embodiments, the training guidance may be preprocessed and/or tokenized prior to being input to the base model. The base model may then process the training guidance to fine-tune its parameters. In some embodiments, the base model may further process an inferred emotional classification and generate emotionally intelligent interaction guidance, which may be evaluated by an authorized user. The authorized user may provide feedback regarding the emotionally intelligent interaction guidance (e.g., quality of recommended actions including word or phrase choice, appropriateness of actions, missing recommended actions, and/or the like) such that the guidance machine learning model may be further fine-tuned based on this feedback.

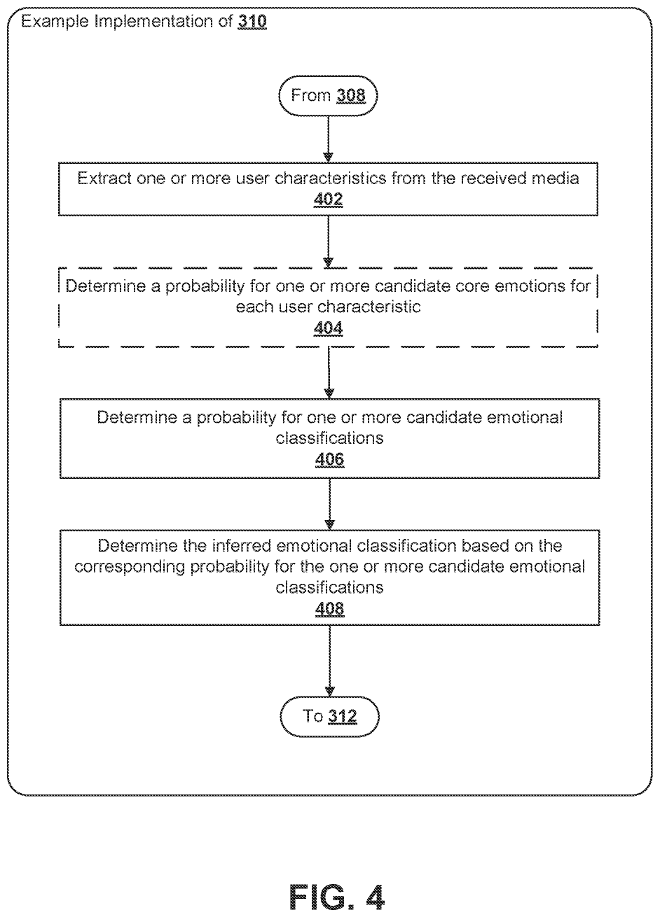

Once trained, the guidance machine learning model may be configured to process the inferred emotional classification for the user and optionally, a user action request, to generate the emotionally intelligent interaction guidance. As described in further detail in FIG. 5, the guidance machine learning model may determine one or more candidate actions and then determine an inferred emotional responsiveness classification for each candidate action. Based on the inferred emotional responsiveness classification, the guidance machine learning model may then select one or more candidate actions and may generate the emotionally intelligent interaction guidance to include these actions as recommended actions and additionally, may include the inferred emotional classification for the user. The guidance machine learning model may then output the emotionally intelligent interaction guidance to the guidance circuitry 212.

In some embodiments, operation 312 may be performed in accordance with the operations described by FIG. 5. Turning now to FIG. 5, example operations are shown for generating emotionally intelligent guidance responsive to a user action request.

Optionally, as shown by operation 502, the apparatus 200 includes means, such as processor 202, memory 204, communications hardware 206, guidance circuitry 212, or the like, for determining a user action request. In some embodiments the guidance circuitry 212 may be configured to determine a user action request. In some embodiments, communications hardware 206 may receive a user action request from an entity device (e.g., any one of entity devices 108A-108N). For example, the frontline agent interacting with the user may use the entity device to facilitate an action requested by the user (e.g., check account balances, manage funds, change user account information, open a new user account, close a user account, and/or the like). In some embodiments, in response to input from the frontline agent, the entity device may provide a user action request may provide the user action request to the communications hardware 206. The guidance circuitry 212 may then determine a user action request from the received user action request.

Alternatively, in some embodiments, the communications hardware 206 may receive a user action request from the user device (e.g., any one of user devices 106A-106N). For example, the user may use his/her user device to access his/her user account online (e.g., via a web browser, mobile application, or the like) and attempt to perform a particular action or preemptively request a particular action, thereby preemptively staging the user action request. The communications hardware 206 may receive the user action request from the user device and determine a user action request from the received user action request.

In some embodiments, the guidance circuitry 212 may be configured to process at least a portion of the received media pertaining to the user to determine a user action request. In some embodiments, the guidance circuitry 212 may use an action inference model to process the media and determine an action request. The action inference model may be a trained neural network (e.g., long short-term memory (LSTM), recurrent neural network (RNN), or the like) that may be trained to apply NLP techniques to infer a user action request. In some embodiments, the action inference model may be configured to process text media specifically. The action inference model may be trained to identify certain keywords or phrases indicative of an inquiry or action request and if these keywords or phrases are detected. In some embodiments, the action inference model may be configured with candidate action requests and may be trained to identify the phrases and/or keywords that correspond to each candidate action request. Additionally, the action inference model may analyze the surrounding context of keywords and/or phrases (e.g., modifiers or other context) to determine a user action request for the user. Once trained, the action inference model may process a portion of the media (e.g., text media) pertaining to the user and may determine whether the media is indicative of a user action request and if so, the type of user action request. The action inference model may output this result to the guidance circuitry 212. In turn, the guidance circuitry 212 may then determine the user action request based on the received user action request determined by the action inference model.

As shown by operation 504, the apparatus 200 includes means, such as processor 202, memory 204, guidance circuitry 212, or the like, for determining one or more candidate actions. The guidance circuitry 212 may use the guidance machine learning model to determine the one or more candidate actions. In particular, the guidance machine learning model may be configured with predefined candidate actions. A candidate action may be indicative of one or more physical, verbal, and/or auditory cues. The candidate action may be associated with content, such as text or image content. In some embodiments, the content may include base content that remains static or unchanged regardless of the particular user. For example, a candidate action may describe a physical cue indicative to wave to the user and this may be base content. In some embodiments, a candidate action may also be associated with dynamic content that is modifiable depending on the particular user. For example, a candidate action may be a verbal cue to greet the user with “good morning [user].” Here, the text “good morning” may be base content while the “[user]” may be dynamic content because it is modifiable depending on whether the identity of the user is known. By way of particular example, if the identity of the user is not known, the dynamic content may be omitted. But if the identity of the user is known, such as in operation 306 and 308, this dynamic content may be replaced with the user's preferred name. In this way, the one or more recommended actions may be generated based on the user account.

In some embodiments, certain candidate actions may only be determined in an instance a user account is determined to satisfy particular criteria. For example, a candidate action of a verbal cue to congratulate the user on his/her recent home purchase, marriage, new child, etc. may only be available if a corresponding user life event is indicated by the user account.

In some embodiments, a candidate action may be associated with a temporal range. The temporal range (e.g., early stage, intermediate stage, end stage) for a given candidate action may control when the candidate action may be considered by the guidance machine learning model. By way of continuing example, the candidate action “good morning [user]” may be associated with an early-stage temporal range such that the guidance machine learning model may only consider this candidate action during early-stage user interactions.

Additionally, a candidate action may be associated with one or more inferred emotional classifications. The inferred emotional classifications associated with a given candidate action may be indicative of when the candidate action should be used to interact with a user of a given inferred emotional classification. For example, a candidate action that includes text of “I'm apologize for the inconvenience” may be associated with inferred emotion classifications of frustrated, aggressive, anger, disappointed, confused. This may restrict the candidate actions the guidance machine learning model may consider for subsequent operations to only candidate actions that are responsive to the inferred emotional state currently being experienced by the user.

As shown by operation 506, the apparatus 200 includes means, such as processor 202, memory 204, guidance circuitry 212, or the like, for determining an inferred emotional responsiveness classification for each candidate action. The guidance circuitry 212 may determine an inferred emotional responsiveness classification for each candidate action using the guidance machine learning model. In particular, the guidance machine learning model may be configured to process the inferred emotional classification determined for the user, and optionally, a user action request. The guidance machine learning model may further consider emotionally intelligent interaction guidance that has already been provided (if any has been provided) such that the guidance machine learning model may also infer a temporal stage of the user interaction (e.g., early stage, intermediate stage, ending stage). Additionally, in some embodiments, if the user identity has been determined and user account has been identified as described in operation 306 and 308, the guidance machine learning model may process emotionally intelligent interaction guidance that has previously been provided to the user.

The guidance machine learning model may then process the various inputs to determine an inferred emotional responsiveness classification for each candidate action. An inferred emotional responsiveness classification may be indicative of whether the candidate action may be helpful, neutral, or not helpful for the user interaction. In some embodiments, the guidance machine learning model may apply various sentiment analysis techniques to determine the inferred emotional responsiveness classification. The inferred emotional responsiveness may consider the inferred emotional classification for the user in view of the current temporal stage and any prior or historical emotionally intelligent guidance provided to the user to determine the inferred emotional responsiveness classification.

As shown by operation 508, the apparatus 200 includes means, such as processor 202, memory 204, guidance circuitry 212, or the like, for determining an inferred emotional responsiveness classification for each candidate action. Once the guidance machine learning model has determined an inferred emotional responsiveness classification, the guidance machine learning model may select one or more candidate actions from the determined candidate actions. In particular, the guidance machine learning model may select the one or more candidate actions associated with a helpful and/or neutral inferred emotional responsiveness. As such, the guidance machine learning model may be configured to selectively include only candidate actions deemed appropriate for the temporal stage of the interaction and in view of the user's current inferred emotional classification.

As shown by operation 510, the apparatus 200 includes means, such as processor 202, memory 204, guidance circuitry 212, or the like, for generating emotionally intelligent interaction guidance to include the one or more selected actions. The guidance machine learning model may then generate the emotionally intelligent interaction guidance to include the one or more selected actions as recommended actions. Additionally, the guidance machine learning model may include the inferred emotional classification for the user in the guidance machine learning model. Furthermore, the guidance machine learning model may provide supplemental information and/or format the recommended actions using NLP techniques. As such, the emotionally intelligent interaction guidance may be formatted for a linear and logical interaction flow for optimal interpretability for the recipient user. The guidance machine learning model may then output the emotionally intelligent interaction guidance to the guidance circuitry 212.

Returning now to FIG. 3A, as shown by operation 314, the apparatus 200 includes means, such as processor 202, memory 204, communications hardware 206, event detection circuitry 208, or the like, for providing the emotionally intelligent interaction guidance. Once the guidance circuitry 212 has generated the emotionally intelligent interaction guidance, the communications hardware 206 may provide the emotionally intelligent interaction guidance to one or more entity devices (e.g., any one of entity device 108A-108N). The emotionally intelligent interaction guidance may be provided to an entity device that is being used by a frontline agent interacting with the user. This may be the same entity device that provided the user action request. Additionally, or alternatively, the event detection circuitry 208 may determine the appropriate entity device based on a location of the user and known locations of the one or more entity devices. Said otherwise, the event detection circuitry 208 may identify an entity device currently in use by a frontline agent that is most proximate to the location of the user and the communications hardware 206 may provide the emotionally intelligent interaction guidance to this entity device.

The provision of the emotionally intelligent interaction guidance to the entity device may cause the emotionally intelligent interaction guidance to be rendered on the entity device or another associated display, such that it may be viewed by the frontline agent. In this way, the frontline agent may view the emotionally intelligent interaction guidance to quickly glean the inferred emotional classification for the user and may follow the recommended actions. Thus, the frontline agent may be provided with a mechanism to enhance user interaction in a manner beneficial for both parties.

In some embodiments, the emotionally intelligent interaction guidance may also be provided to one or more predefined entity devices (e.g., any one of entity devices 108A-108N). The one or more predefined entity devices may be associated with a manager, supervisor, or other administrative agent who may wish to be informed on how current user interactions are proceeding. Thus, in some embodiments, the emotionally intelligent interaction guidance may be provided to administrative users. These predefined entity devices may be configured to display emotionally intelligent interaction guidance from multiple frontline agent and user interactions. As such, the administrative users may be provided with an overview of how one or more user interactions are progressing within the given environment. Furthermore, the provided emotionally intelligent interaction guidance may be stored by the entity device such that an administrative user can view user interactions for each frontline agent, such as for quality assurance purposes. Additionally, the administrative user may be provided with a mechanism that can alert him/her if a particular frontline agent has received a high volume of emotionally difficult users, such that the administrative user may proactively step in and relieve the frontline agent.

In some embodiments, the emotionally intelligent interaction guidance may be stored in an associated user account if a user account was identified for the user in operation 308. This emotionally intelligent interaction guidance may be subsequently used by guidance circuitry 212 to generate emotionally intelligent interaction guidance for a subsequent user interaction event by the user. Additionally, or alternatively, the emotionally intelligent interaction guidance may be evaluated by administrative users for quality assurance purposes, such as in response to user inquiries and/or complaints related to the user interaction event. In some embodiments, the emotionally intelligent interaction guidance may be used by the emotion analysis circuitry 210 guidance circuitry 212 to retrain or fine-tune the emotional intelligence machine learning model and/or the guidance machine learning model, respectively.

Optionally, as shown by operation 316, the apparatus 200 includes means, such as processor 202, memory 204, communications hardware 206, guidance circuitry 212, or the like, for causing one or more changes in the environment. In some embodiments, the guidance circuitry 212 may further cause one or more changes in the environment. In some embodiments, these environmental settings may be controlled by the guidance circuitry 212. Environmental settings may include environmental lighting, environmental music, environmental temperature, environmental fragrance, and/or the like. The guidance circuitry 212 may be configured with optimal environmental settings for each inferred emotional classification. In some embodiments, optimal environmental settings may describe a current state (e.g., on/off), acceptable categories (e.g., music type), particular value (e.g., light intensity, light color, and/or the like), value range, and/or the like for a given environmental parameter.

The guidance circuitry 212 may compare the current environmental settings to the optimal environmental settings for a given user's inferred emotional classification. In some embodiments, in an instance in which multiple users are within the environment, the guidance circuitry 212 may be configured to perform one or more mathematical and/or logical operations to determine composite optimal environmental settings considerate of each user's inferred emotional classification. For example, the guidance circuitry 212 may weigh the optimal environmental settings for an inferred emotional classification based on the number of users present that are associated with that inferred emotional classification for each user in the environment to determine the composite optimal environmental settings.

Once the guidance circuitry 212 has determine the optimal environmental settings (or composite optimal environmental settings), the guidance circuitry 212 may provide, via communications hardware 206, a corresponding signal to each entity device (e.g., any one of entity devices 108A-108N) that controls a given environmental setting. For example, the guidance circuitry 212 may provide a signal indicative to lower the current lighting setting to a new lighting setting to a lighting control panel entity device. The lighting control panel entity device may then adjust the lighting settings to the new lighting settings. In this way, the guidance circuitry 212 may maintain and control the environment to also help facilitate a more pleasant user interaction experience.

Continuing now to FIG. 3B, as shown by operation 318, the apparatus 200 includes means, such as processor 202, memory 204, communications hardware 206, event detection circuitry 208, or the like, for receiving updated media that pertains to the user. In some embodiments, once a user interaction event is detected, the communications hardware 206 may continue to receive media pertaining to the user for the duration of the user interaction event. This updated media may be continuously or at periodic intervals (e.g., every five seconds, ten seconds, or the like). The communications hardware 206 may receive update media that pertains to the user in a substantially similar manner as described in operation 302.

As shown by operation 320, the apparatus 200 includes means, such as processor 202, memory 204, event detection circuitry 208, or the like, for detecting whether a user interaction termination event has occurred. A user interaction termination event may be indicative of the end of the user interaction event. Thus, this may be indicative that emotionally intelligent interaction guidance no longer needs to be provided for the given user as user interaction is no longer occurring and as such, subsequently received media can be ignored. In some embodiments, the event detection circuitry 208 may use the one or more user detection models to detect the user interaction termination event. In some embodiments, the user detection may also be trained to process the received data and output an indication of whether a user interaction event termination event is detected (e.g., a classification of “ongoing user interaction event” or “no user interaction event”, a Boolean value of “true” or “false”, and/or the like). In some embodiments, the user detection model may use one or more image processing techniques, such as object detection techniques, to identify users within the data/media (e.g., images and/or videos). Alternatively, the user detection model may use other text-based data processing techniques. In some embodiments, the user detection model may be configured to determine an affirmative user interaction termination event in an instance in which the user is no longer detected or captured by media within the environment. For example, if the user leaves the environment such that he/she is no longer captured in received media, the user detection model may determine a user interaction termination event.

In an instance in which a user interaction termination event has been detected, the process proceeds to back to operation 302. As described above, if a user interaction termination event is determined, the user is no longer within the environment and thus, no further user interaction is occurring. Therefore, the process may return to operation 302 to detect a next user interaction event for another user.

In an instance in which a user interaction termination event is not detected, the process proceeds to operation 322. At operation 322, apparatus 200 includes means, such as processor 202, memory 204, emotion analysis circuitry 210, or the like, for determining an updated inferred emotional classification for the user. If a user interaction termination event is not detected, then the user remains within the environment and user interaction may still be occurring. Thus, the received updated media should be processed to determine an updated inferred emotional classification for the user. As will be appreciated, user emotions may fluctuate throughout the duration of their visit. Thus, an updated inferred emotional classification should be determined for the user in order to capture the most up-to-date emotional state of the user such that appropriate emotionally intelligent guidance can be provided. Thus, the emotion analysis circuitry 210 may use the emotional intelligence machine learning model and/or preprocessing models to process the updated media to determine the updated inferred emotional classification for the user. This operation may be performed in a substantially similar manner as described in operation 310 and the various operations of FIG. 4.

As shown by operation 324, the apparatus 200 includes means, such as processor 202, memory 204, guidance circuitry 212, or the like, for generating the emotionally intelligent interaction guidance. Once the emotion analysis circuitry 210 has determined the updated inferred emotional classification for the user, the guidance circuitry 212 may update the emotionally intelligent guidance. In particular, the guidance circuitry 212 may use the guidance machine learning model to process the updated emotionally intelligent guidance and update the temporal information to update the emotionally intelligent interaction guidance. This operation may be performed in a substantially similar manner as described in operation 312 and the various operations of FIG. 5.

As shown by operation 326, the apparatus 200 includes means, such as processor 202, memory 204, communications hardware 206, or the like, for providing the updated emotionally intelligent interaction guidance. Once the guidance circuitry 212 has updated the emotionally intelligent interaction guidance, the communications hardware 206 may provide the updated emotionally intelligent interaction guidance to one or more entity devices (e.g., any one of entity devices 108A-108N). This operation may be performed in a substantially similar manner as described in operation 314. Upon receipt of the updated emotionally intelligent interaction guidance, the recipient entity device and/or associated display may replace the previous emotionally intelligent interaction guidance with the updated emotionally intelligent interaction guidance. As such, the frontline agent and/or administrative user may be provided with an up-to-date reflection of the user's current inferred emotional classification and update recommended actions. This may allow the frontline agent and/or administrative user to be responsive to the user's current needs. This updated emotionally intelligent interaction guidance may also be stored in an associated user account if such a user account was identified in operation 308.

Optionally, as shown by operation 328, the apparatus 200 includes means, such as processor 202, memory 204, communications hardware 206, guidance circuitry 212, or the like, for causing one or more changes in the environment. The guidance circuitry 212 may cause one or more changes to the environment in an instance in which the updated inferred emotional classification for the user has changed. In particular, the guidance circuitry 212 may determine the optimal environmental settings or composite optimal environmental settings based on the updated inferred emotional classification. This operation may be performed in a substantially similar manner as described in operation 316. In an instance in which the optimal environmental settings or composite optimal environmental settings deviates from the previously determined optimal environmental settings or composite optimal environmental settings, the guidance circuitry 212 may provide, via communications hardware 206, a corresponding signal to each entity device (e.g., any one of entity devices 108A-108N) to result in the environmental changes.

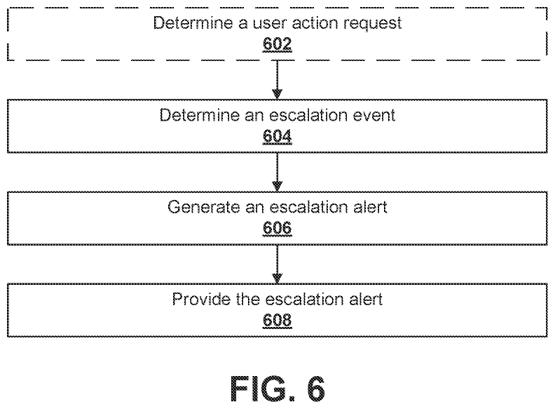

The operations of FIGS. 3A-5 are further summarized by the schematic block diagram of FIG. 7. FIG. 7 shows an example model framework 701 that may be used to generate and provide emotionally intelligent interaction guidance. The model framework 701 includes a preprocessing model 705 that may receive media pertaining to the user and process the media to generate user characteristics. The user characteristics may then be provided to the emotional intelligence machine learning model 710 to determine the inferred emotional classification to the user. The inferred emotional classification may then be provided to the guidance machine learning model 715, which may process the inferred emotional classification to generate the emotionally intelligent interaction guidance that is then output for use.

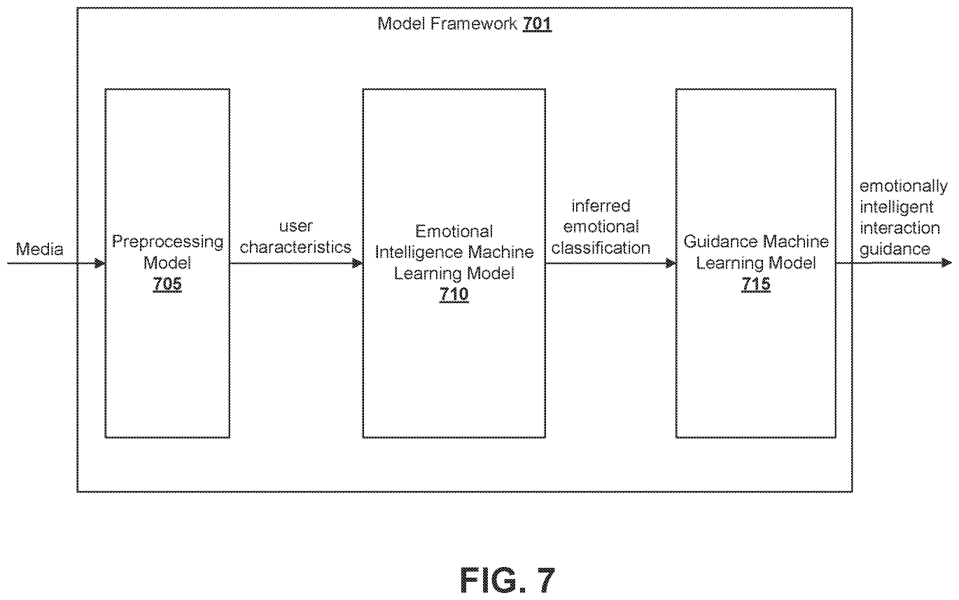

Turning to FIGS. 8A-8C, graphical user interfaces (GUIs) that illustrate examples of emotionally intelligent guidance that may be displayed to a frontline agent are provided. The GUI shown in FIGS. 8A-8C may be displayed to a frontline agent by the entity device (e.g., any one of entity devices 108A-108N, as shown in FIG. 1), which may communicate with the interaction guidance system 102 via communications network 104.

As shown in FIG. 8A, the emotionally intelligent interaction guidance 800 may include the inferred emotional classification 801 determined for the user. The emotionally intelligent interaction guidance 800 may further include recommended actions 802 that may prompt the frontline agent on verbal cues, physical cues, or auditory cues that may be used to interact with the user. Additionally, in this example, the emotionally intelligent interaction guidance 800 also provided the user's name and a preferred name for the user. This may be available in instances in which the user identity has been determined and a user account identified. The user account may be indicative of the user's name, preferred name, and/or other preferences that the frontline agent may use to facilitate the user interaction.

Turning now to FIG. 8B, an updated emotionally intelligent interaction guidance 820 may include the updated inferred emotional classification 821 determined for the user during the same user interaction event as FIG. 8A. Here, the updated emotionally intelligent interaction guidance 820 may further include updated recommended actions 822 that may prompt the frontline agent to provide certain verbal cues, physical cues, or auditory cues to the user.

Turning now to FIG. 8C, a subsequent updated emotionally intelligent interaction guidance 840 may include the updated inferred emotional classification 841 determined for the user during the same user interaction event as FIGS. 8A and 8B. Here, the updated emotionally intelligent interaction guidance 840 may further include updated recommended actions 842 that may prompt the frontline agent on verbal cues, physical cues, or auditory cues that may be used to interact with the user.

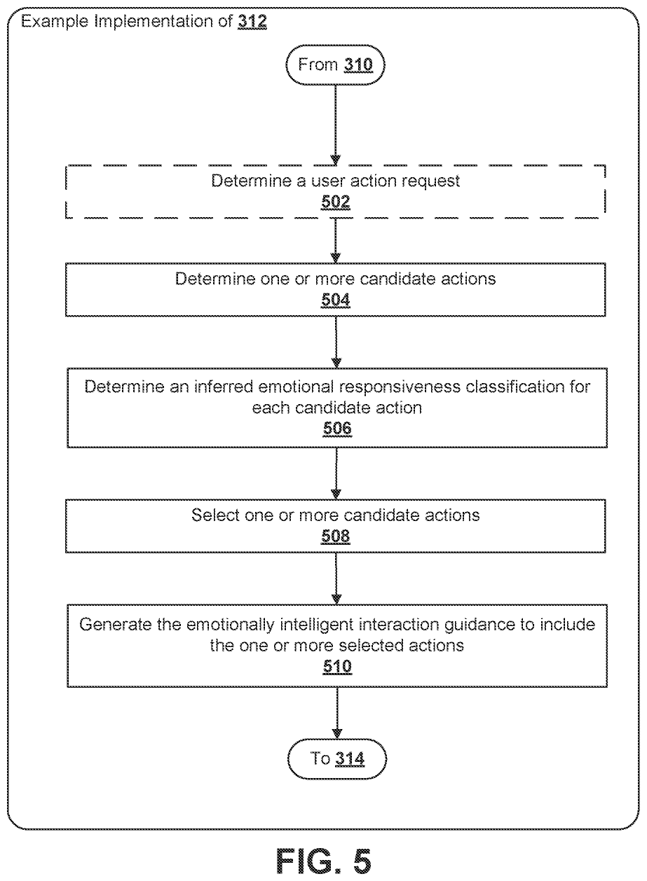

Turning now to FIG. 6, example operations are shown for responding to an escalation alert. Optionally, as shown by operation 602, the apparatus 200 includes means, such as processor 202, memory 204, guidance circuitry 212, or the like, for determining a user action request. In some embodiments the guidance circuitry 212 may be configured to determine a user action request. This operation may be performed in a substantially similar manner as described in operation 502 of FIG. 5. As described above, a user action request may be a request by the user to perform a particular action or operation. For example, a user action request may be a request to check account balances, manage funds, change user account information, open a new user account, close a user account, and/or the like.

As shown by operation 604, the apparatus 200 includes means, such as processor 202, memory 204, guidance circuitry 212, or the like, for determining an escalation event. In some embodiments, the guidance circuitry 212 may determine an escalation event in addition to generating the emotionally intelligent interaction guidance. In particular, the guidance circuitry 212 may use the guidance machine learning model to determine the escalation event. The guidance machine learning model may determine an escalation event based on the inferred emotional classification determined for the user. The guidance machine learning model may be configured to output whether an escalation event has been determined to the guidance circuitry 212. Furthermore, if an escalation event has been determined, the guidance machine learning model may further include the type of escalation event that has been determined.

The guidance machine learning model may be configured to automatically identify certain inferred emotional classifications to warrant an escalation event. For example, a particular inferred emotional classification, such as may as an aggressive inferred emotional classification, may automatically trigger the guidance machine learning model to determine an escalation event. These inferred emotional classifications may immediately trigger an escalation event due to safety and/or security concerns. This may be a safety escalation event. Thus, an escalation event may be determined to alert security officers, police officers, and/or other security personnel that the user is a potential threat such that they may intervene to deescalate or handle the situation.

Alternatively, the guidance machine learning model may be configured to monitor for a change in the inferred emotional classification of a user over time and may determine an escalation event based on whether a change is determined. For example, a frustrated inferred emotional classification may not automatically trigger an escalation event. However, if a frustrated inferred emotional classification is maintained for the user for a threshold period of time (e.g., five minutes), the guidance machine learning model may determine an escalation event. This may be a user experience escalation event. Here, the guidance machine learning model may determine an escalation event due to the continued negative emotions experienced by the user which the frontline agent has not been able to resolve. Thus, an escalation event may be triggered to alert mangers, supervisors, or other personnel that their assistance may be required in order to aid the user with his/her request.

As another example, a user experience escalation event may be determined in an instance in which the user's inferred emotional classification and/or activity appears to be indicative of fraud. For example, an inferred emotional classification of nervous may automatically trigger a user experience escalation event. In some embodiments, the user experience escalation event may only be triggered in an instance in which a qualifying inferred emotional classification (e.g., nervous) and a qualifying type of user action request is determined. For example, a user action request may be to withdraw funds from a user account. In an instance in which a nervous inferred emotional classification is also determined for the user, this may cause the guidance circuitry 212 to determine an escalation event. Thus, a supervisor, manager, or the like may be alerted to the potential fraud and may take additional steps to intervene, such as requiring additional security and/or authentication from the user.

In an instance in which an escalation event is determined for the user, an indication of the escalation event may be included in the emotionally intelligent interaction guidance. As such, a frontline agent and/or administrative user may be made aware of that an escalation event has been determined and that an appropriate party has been alerted. Additionally, the type of escalation event (e.g., a safety or user experience escalation event) may be included in the emotionally intelligent interaction guidance.

As shown by operation 606, the apparatus 200 includes means, such as processor 202, memory 204, guidance circuitry 212, or the like, for generating an escalation alert. If the guidance circuitry 212 has determined an escalation event, the guidance circuitry 212 may then generate an escalation alert indicative of the escalation event. The escalation alert may be indicative of the type of escalation event determined. Additionally, the escalation alert may include details pertaining to the user involved in the escalation event. For example, the inferred emotional classification of the user may be included in the escalation event. Additionally, or alternatively, the related media and/or a user location may be included in the escalation event such that the user may identified and/or located.

As shown by operation 608, the apparatus 200 includes means, such as processor 202, memory 204, communications hardware 206, or the like, for providing the escalation alert. Once the guidance circuitry 212 has generated the escalation alert, the communications hardware 206 may provide the escalation to one or more entity devices (e.g., any one of entity devices 108A-108N). The entity device that is provided with the escalation alert may be a different entity device than the entity device that is provided with the emotionally intelligent interaction guidance and/or updated emotionally intelligent interaction guidance.

The communications hardware 206 may be configured to provide the escalation alert to one or more predefined entity devices (e.g., any one of entity devices 108A-108N). The particular predefined entity device may be dependent upon the type of escalation event that was determined. For example, the communications hardware 206 may provide the escalation alert to an entity device associated with a security officer, police officer, or other security personnel for a safety escalation event type. However, the communications hardware 206 may provide the escalation alert to an entity device associated with a manager, supervisor, or other administrative agent for a user experience escalation event type. Thus, in some embodiments, the emotionally intelligent interaction guidance may be provided to administrative users. These predefined entity devices may be configured to display the escalation alert such that the recipient agent or personnel may be alerted to the escalation event and take appropriate action.

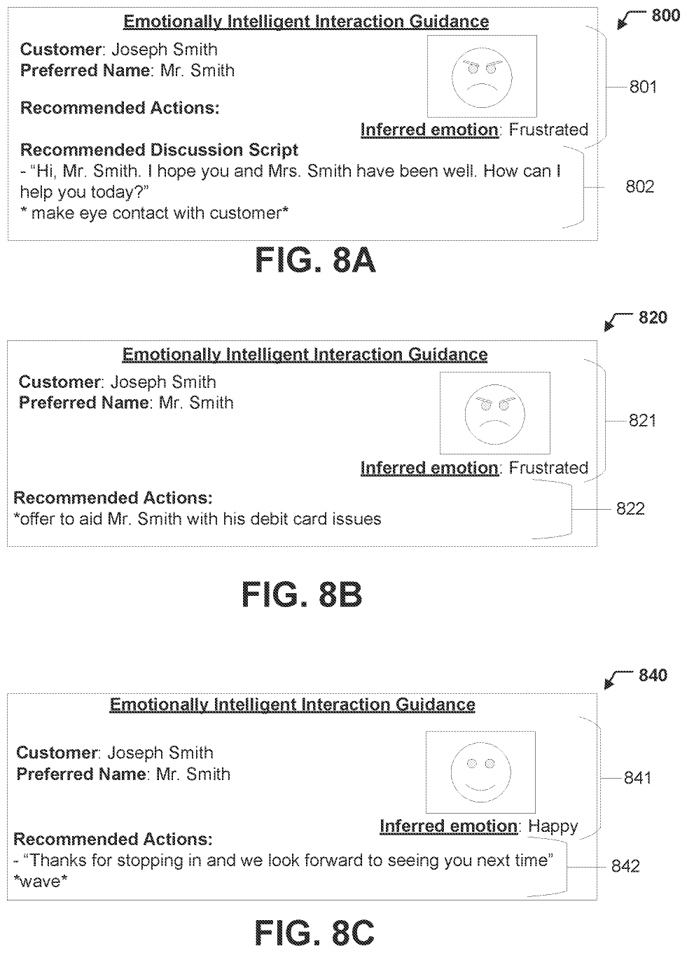

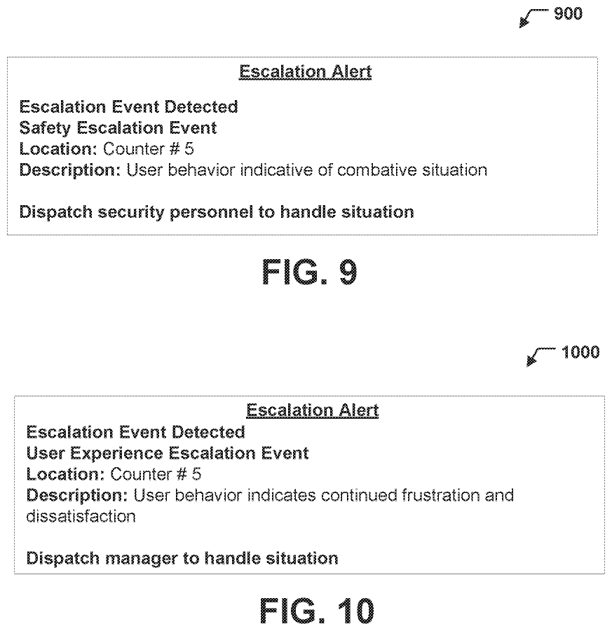

Turning to FIGS. 9 and 10, graphical user interfaces (GUIs) are provided that illustrate examples of escalation alerts that may be displayed to users or agents other than the frontline agent. The GUI shown in FIGS. 9 and 10 may be displayed to these users by an entity device (e.g., any one of entity devices 108A-108N, as shown in FIG. 1), which may communicate with the interaction guidance system 102 via communications network 104.

As shown in FIG. 9, the escalation alert 900 may indicate that an escalation event has been determined and further, may indicate the type of escalation event (e.g., safety or user experience). In FIG. 9, a safety escalation event may have been determined. Additionally, the escalation alert 900 may include a user location as well as a description of the user's behaviour. The escalation alert 900 may further include a recommended action to manage the escalation event (e.g., dispatch security personnel to manage the potentially combative situation).

Turning now to FIG. 10, the escalation alert 1000 may be a user experience escalation event. The escalation alert 1000 may also include a user location as well as a description of the user's behaviour. The escalation alert 1000 may further include a recommended action to manage the escalation event (e.g., dispatch manager to takeover user interaction and alleviate user dissatisfaction and frustration).

FIGS. 3A-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable enhanced and improved user interaction. Example embodiments thus provide tools that overcome the problems faced by conventional methods, which rely on frontline agents to handle user interactions without guidance. As such, example embodiments described herein do away with the conventional approaches and allow for the provision of emotionally intelligent interaction guidance that is responsive to the user's current inferred emotional classification to these frontline agents. In this way, the frontline agent may be automatically presented with guidance on how to handle each user interaction in an emotionally intelligent manner.

Furthermore, the inferred emotional classification determined for the user may inform other environmental operations. In particular, the environmental settings may be altered in a responsive manner based on the user's inferred emotional classification such that the user experience is enhanced. Additionally, escalation events may be determined based on the user's inferred emotional classification, thereby improving the safety, security, and overall customer experience for all individuals within the environment.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing emotionally intelligent interaction guidance, the method comprising:
detecting, by event detection circuitry, a user interaction event for a user within an environment;
receiving, by communications hardware, media pertaining to the user;
inferring, by an emotion analysis circuitry and using an emotional intelligence machine learning model, an emotional classification for the user based on the received media, wherein the inferred emotional classification is associated with a probability that the user possesses an emotion corresponding to the inferred emotional classification;
generating, by a guidance circuitry and using a guidance machine learning model, the emotionally intelligent interaction guidance based on the inferred emotional classification, wherein the emotionally intelligent interaction guidance indicates the inferred emotional classification and a recommended action for interacting with the user; and
providing, by the communications hardware, the emotionally intelligent interaction guidance to an entity device.

2. The method of claim 1, further comprising:
extracting, by the emotion analysis circuitry and using a preprocessing model, one or more user characteristics from the received media; and
determining, by the emotion analysis circuitry and using the emotional intelligence machine learning model, a probability for a candidate emotional classification based on the one or more user characteristics, wherein the inferred emotional classification is also determined based on a corresponding probability for the candidate emotional classification.

3. The method of claim 2, further comprising:
determining, by the emotion analysis circuitry and using the emotional intelligence machine learning model, a probability for one or more candidate core emotions based on the one or more user characteristics,
wherein determining the probability for the one or more candidate emotional classifications is based on the probability determined for the one or more candidate core emotions.

4. The method of claim 2, wherein the one or more user characteristics comprises one or more of a user facial expression, user body language, a user gesture, a user voice tone, a user voice volume, a user speech speed, a user speech patterns, user eye contact behavior, user speech text, or user physiological responses.

5. The method of claim 1, further comprising:
determining, by the guidance circuitry and using the guidance machine learning model, one or more candidate actions;
determining, by the guidance circuitry and using the guidance machine learning model, an inferred emotional responsiveness classification for each of the one or more candidate actions; and
selecting, by the guidance circuitry and using the guidance machine learning model, at least one of the one or more candidate actions based on a comparison between the inferred emotional classification and the inferred emotional responsiveness classification for each of the one or more candidate actions, wherein the emotionally intelligent interaction guidance comprises the selected one or more candidate actions.

6. The method of claim 1, further comprising:
determining, by the guidance circuitry and using the guidance machine learning model, an escalation event based the inferred emotional classification for the user, wherein the emotionally intelligent interaction guidance is further indicative of the escalation event;
generating, by the guidance circuitry, an escalation alert indicative of the escalation event; and
providing, by the communications hardware, the escalation alert, to a second entity device different than the entity device.

7. The method of claim 1, further comprising:
for a duration of the user interaction event:
receiving, by the communications hardware, updated media pertaining to the user;
determining, by the emotion analysis circuitry and using the emotional intelligence machine learning model, an updated inferred emotional classification for the user based on the received updated media;
generating, by the guidance circuitry and using the guidance machine learning model, updated emotionally intelligent interaction guidance based on the updated inferred emotional classification; and
providing, by the communications hardware, the updated emotionally intelligent interaction guidance to the entity device.

8. The method of claim 1, further comprising causing, by the guidance circuitry, one or more changes within the environment based on the inferred emotional classification.

9. The method of claim 1, further comprising:
determining, by the event detection circuitry, a user identity of the user based on the received media; and
identifying, by the event detection circuitry, a user account for the user based on the user identity, wherein (a) the user account includes one or more of user preferences, user life events, or historical user interaction events and (b) the recommended action is generated based on the user account.

10. The method of claim 1, wherein the recommended action comprises instructions to provide one or more verbal cues, physical cues, or auditory cues to the user.

11. An apparatus for providing emotionally intelligent interaction guidance, the apparatus comprising:
event detection circuitry configured to detect a user interaction event for a user within an environment;
communications hardware configured to receive media pertaining to the user;
emotion analysis circuitry configured to infer, using an emotional intelligence machine learning model, an emotional classification for the user based on the received media, wherein the inferred emotional classification is associated with a probability that the user possesses an emotion corresponding to the inferred emotional classification; and
guidance circuitry configured to generate, using a guidance machine learning model, the emotionally intelligent interaction guidance based on the inferred emotional classification, wherein the emotionally intelligent interaction guidance indicates the inferred emotional classification and a recommended action for interacting with the user,
wherein the communications hardware is further configured to provide the emotionally intelligent interaction guidance to an entity device.

12. The apparatus of claim 11, wherein the emotion analysis circuitry is further configured to:
extract, using a preprocessing model, one or more user characteristics from the received media; and
determine, using the emotional intelligence machine learning model, a probability for a candidate emotional classification based on the one or more user characteristics, wherein the inferred emotional classification is also determined based on a corresponding probability for the candidate emotional classification.

13. The apparatus of claim 12, wherein the emotion analysis circuitry is further configured to:
determine, using the emotional intelligence machine learning model, a probability for a candidate core emotion based on the one or more user characteristics,
wherein determining the probability for the one or more candidate emotional classifications is based on the probability determined for the one or more candidate core emotions.

14. The apparatus of claim 12, wherein the one or more user characteristics comprises one or more of a user facial expression, user body language, a user gesture, a user voice tone, a user voice volume, a user speech speed, a user speech patterns, user eye contact behavior, user speech text, or user physiological responses.

15. The apparatus of claim 11, wherein the guidance circuitry is further configured to:
determine, using the guidance machine learning model, one or more candidate actions;
determine, using the guidance machine learning model, an inferred emotional responsiveness classification for each of the one or more candidate actions; and
select, using the guidance machine learning model, one or more of the one or more candidate actions based on a comparison between the inferred emotional classification and the inferred emotional responsiveness classification for each of the one or more candidate actions, wherein the emotionally intelligent interaction guidance comprises the selected one or more candidate actions.

16. The apparatus of claim 11, wherein the guidance circuitry is further configured to:
determine, using the guidance machine learning model, an escalation event based the inferred emotional classification for the user, wherein the emotionally intelligent interaction guidance is further indicative of the escalation event, and
generate an escalation alert indicative of the escalation event,
wherein the communications hardware is further configured to provide the escalation alert to a second entity device different than the entity device.

17. The apparatus of claim 11, wherein, for a duration of the user interaction event:
the communications hardware is further configured to receive updated media pertaining to the user;
the emotion analysis circuitry is further configured to determine, using an emotional intelligence machine learning model, an updated inferred emotional classification for the user based on the received updated media;
the guidance circuitry is further configured to generate, using the guidance machine learning model, updated emotionally intelligent interaction guidance based on the updated inferred emotional classification; and
the communications hardware is further configured to provide the updated emotionally intelligent interaction guidance to the entity device.

18. The apparatus of claim 11, further wherein the guidance circuitry is further configured to cause one or more changes within the environment based on the inferred emotional classification.

19. The apparatus of claim 11, wherein the event detection circuitry is further configured to:
determine a user identity of the user based on the received media; and
identify a user account for the user based on the user identity, wherein (a) the user account includes one or more of user preferences, user life events, or historical user interaction events and (b) the recommended action is generated based on the user account.

20. A computer program product for providing emotionally intelligent interaction guidance, the computer program product comprising at least one non-transitory computer-readable storage medium storing software instructions that, when executed, cause an apparatus to:
detect a user interaction event for a user within an environment;
receive media pertaining to the user;
infer, using an emotional intelligence machine learning model, an emotional classification for the user based on the received media, wherein the inferred emotional classification is associated with a probability that the user possesses an emotion corresponding to the inferred emotional classification;
generate, using a guidance machine learning model, the emotionally intelligent interaction guidance based on the inferred emotional classification, wherein the emotionally intelligent interaction guidance indicates the inferred emotional classification and a recommended action for interacting with the user; and
provide the emotionally intelligent interaction guidance to an entity device.
